(19) United States
(12) Patent Application Publication
(10) Pub. No.: US 2011/0316692 A1
(43) Pub. Date: Dec. 29, 2011

(54) SPACE LOCATION DEVICE, ASSOCIATED REFERENCE TRANSMITTER AND LOCATION SYSTEM

(75) Inventors: Jean-Marc Aubert, Gemenos (FR); Peter Miles, St Cyr Sur Mer (FR); Pascal Genest, La Destrousse (FR)

(73) Assignee: TALISMART, Gémenos (FR)

(21) Appl. No.: 13/255,841

(22) PCT Filed: Mar. 9, 2010
(86) PCT No.: PCT/FR2010/050402

§ 371 Date: Sep. 9, 2011

(30) Foreign Application Priority Data
Mar. 11, 2009 (FR) 09/01112

(51) Int. Cl. G08B 1/08

(52) U.S. Cl. 340/539.1

(57) ABSTRACT

The invention pertains to the field of systems for locating a person, an animal, a vegetable, a parcel or more generally any entity mobile in motion or that can be moved. More precisely, the invention relates to a location device that comprises means for receiving an identification message transmitted by a reference transmitter, said identification message comprising an identifier dedicated to said reference transmitter. Said device also comprises means for determining, from a plurality of reference transmitters each having transmitted an identification message, the reference transmitter that is spatially closest to the device.

The invention pertains to the field of systems for locating a person, an animal, a vegetable, a parcel or more generally any entity mobile in motion or that can be moved.

As a matter of fact, it is useful or even indispensable to be able to determine the position of such an entity, for example, in an industrial area, a warehouse, a building, with an accuracy more particularly making it possible to identify the floor within the building or any industrial or farm site, if need be.

Various techniques, sometimes complementary to each other, exist nowadays to obtain a more or less accurate location, among which the detection of the proximity of a reference transmitter of the short range “beacon” type, to determine the position of a mobile receiver. However, this technique requires the passages through precise places of a building to be memorised in order to determine the floor where said receiver is located. Then, a very short range beacon is frequently found at each landing of a stairway. In addition, it is necessary, in order to find the current position of the mobile receiver, to compare a sequenced list of passages with a circulation diagram.

The same is true for another known solution which consists in using information supplied by an access control system using electronic labels communicating through radio. This technique makes it possible to deduce the position of a call by consulting a list of the last points of the passage.

Determining the distances covered by various synchronous radio signals issued by transmitters, the positions of which are known makes it possible, in addition, to determine the position of a mobile receiver by triangulation, for example, using transmitters aboard satellites (Global Positioning System, Galileo). However, this technology remains little efficient, more particularly within a building, considering the bad reception of signals transmitted by satellites. In addition, the precision required for identifying a floor requires a time resolution of a few nanoseconds. Such a precision cannot be obtained but with electronics operating at high frequencies implying a significant power consumption as a counterpart.

Other techniques exist yet, among which the analysing of electromagnetic signals received which is carried out in some hyperbolic navigation systems (DECCA, Omega, TORAN). As this technology is particularly sensitive to multipath of radio waves, it is almost impossible to implement it within a building.

Eventually, measuring the fading of signal strength (Received Signal Strength Identification or RSSI) as a function of the distance covered may make it possible to determine a position in a free space while applying triangulation techniques. Such a technique, however, meets several major difficulties which reduce the reliability of the measurement, more particularly if obstacles, for instance metallic objects, exist in the vicinity . . .

The invention provides a solution to the drawbacks and the overcoming of the limits of the known solutions by providing an innovating and efficient technique for locating an electronic location device associated with a person, an animal, an object liable to be moved or mobile without requiring the storing of prior positions. The invention enables an accurate location, more particularly of the floor where said device is located without a high density of reference transmitters being required.

In addition, the method for locating the device according to the invention can be initiated by the device itself. Among the numerous advantages offered by the invention, the location device includes electronic means which can remain off or in a standby condition during most of the utilisation time. The power consumption can thus be particularly optimised, which results in a very high reliability and continuity with maintenance operation being largely avoided.

One particular application of the invention is in the field of the protection of persons' lives. Then, the invention enables an individual to trigger a distress call within a building in order to be rapidly and accurately located. This location does not require a regular or even a continuous follow-up of motions contrary to the known solutions, as said follow-up is often considered as liable to be an invasion of privacy during a person's travels.

The invention can also be applied to the follow-up and location of objects such as portable care devices in hospitals, the follow-up of high value pallets in warehouses, and the follow-up and watching of animals. However, the universal characteristic of the invention cannot be limited to such applications.

For this purpose, there is provided more particularly a location device including:
means for receiving an identification message transmitted by a reference transmitter, said identification message including an identifier dedicated to said reference transmitter,
means for analysing a collision of identification messages and determining a preponderant identification message among the latter in order to identify the reference transmitter that is spatially the closest to the device, among the plurality of reference transmitters, each having simultaneously transmitted an identification message.

According to one embodiment, said device may include means for transmitting a request for location to a plurality of reference transmitters so that the latter can simultaneously transmit backward an identification message.

The invention further provides that the location device may include means for triggering the means for transmitting a request for location. The latter can also include means for knowing the reference transmitter or transmitters able to transmit an identification message thereto. According to one embodiment, said means for knowing the transmitters able to transmit an identification message may include a transmitters table stored in the memory of the location device. Said table may include one input for each reference transmitter able to transmit an identification message, with said input including an identifier dedicated to the reference transmitter.

The invention provides for an alternate embodiment according to which the means for knowing the reference transmitters able to transmit an identification message can:
transmit a request for display to any reference transmitter;
receive backward a display message transmitted by any reference transmitter able to answer said request for display;
read an identifier dedicated to said transmitter in said display message;
create one input in the transmitters table for each reference transmitter having transmitted a display message.

It can also be provided for each input in the transmitters table to include a counter. According to this alternative solution, the means for triggering a request for location may trigger a plurality of transmissions of requests to known transmitters. Then, the means for determining the reference transmitter that is spatially the closest to said device can:
determine, for each request for location, the transmitter, the identifier of which is read in the identification message received among the plurality of simultaneously transmitted identification messages;
increment the value of the counter in the input of the transmitters table associated with said read identifier;
determine, upon the completion of all the requests for location, the reference transmitter, the value of the associated counter of which is the highest, as being the reference transmitter that is spatially the closest to the device.

According to a preferred embodiment, the device may include means for transmitting a location message including, for example, the identifier of the reference transmitter that is spatially the closest.

A location device according to the invention may further include means for transmitting an alert message of the radio, sound, vibration and/or light alert type.

When the device is able to trigger a request for location, the triggering means may include a processing unit for analysing a measurement issued by a sensor.

As an alternative solution, it may include means for receiving an alert message transmitted by a second device and transmit a request for location upon reception of said alert message.

The invention further provides for a reference transmitter provided with means for transmitting an identification message including an identifier dedicated to said reference transmitter, to a location device according to the invention.

Such a reference transmitter may include means for triggering means for transmitting an identification message to said device. As an alternative solution, a reference transmitter may include means for receiving a request for location transmitted by a location device according to the invention and thus be able to transmit an identification message upon reception of said request for location.

The invention provides that the reference transmitter may include means for transmitting a display message including an identifier dedicated to said transmitter, as an answer to the reception of a request for display transmitted by a device according to the invention.

The invention also provides for a system including at least one location device and at least two reference transmitters according to the invention. As an alternative, such a system may include means for processing a location message transmitted by a location device.

Other characteristics and advantages will appear more clearly when reading the following description and referring to the appended Figures among which:

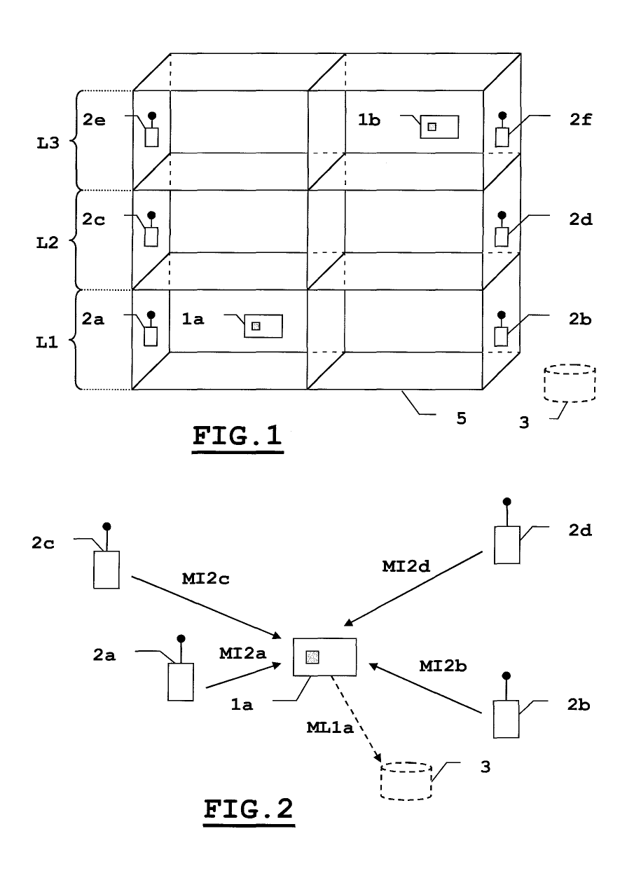

FIG. 1 shows an exemplary implementation of the invention within a building;

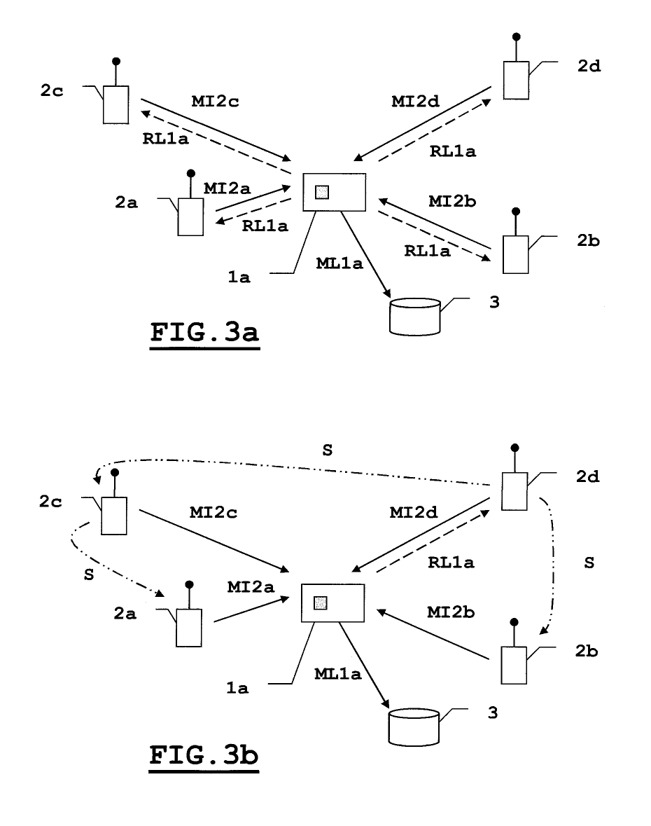

FIGS. 2, 3a and 3b show alternative embodiments of a location device and reference transmitters according to the invention;

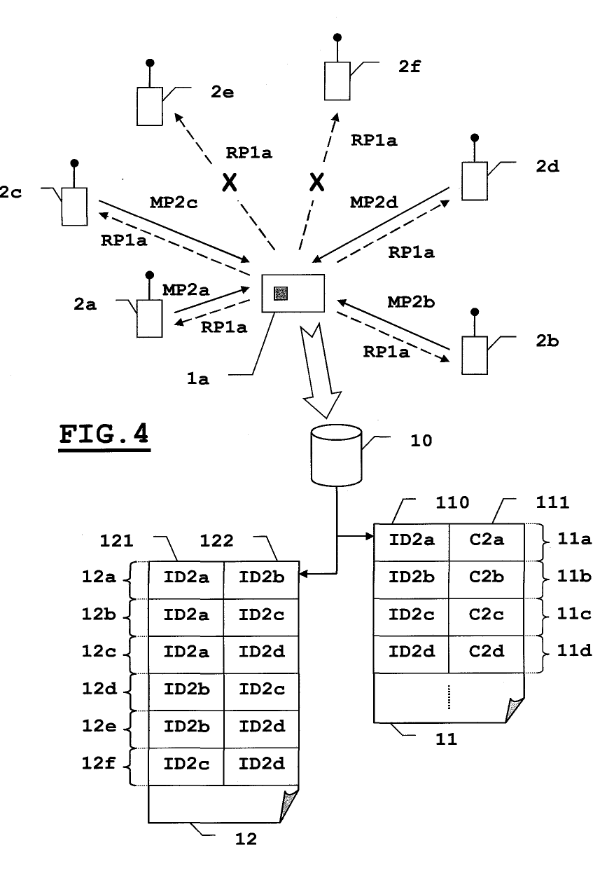

FIG. 4 shows a process of display of reference transmitters with respect to a location device according to the invention;

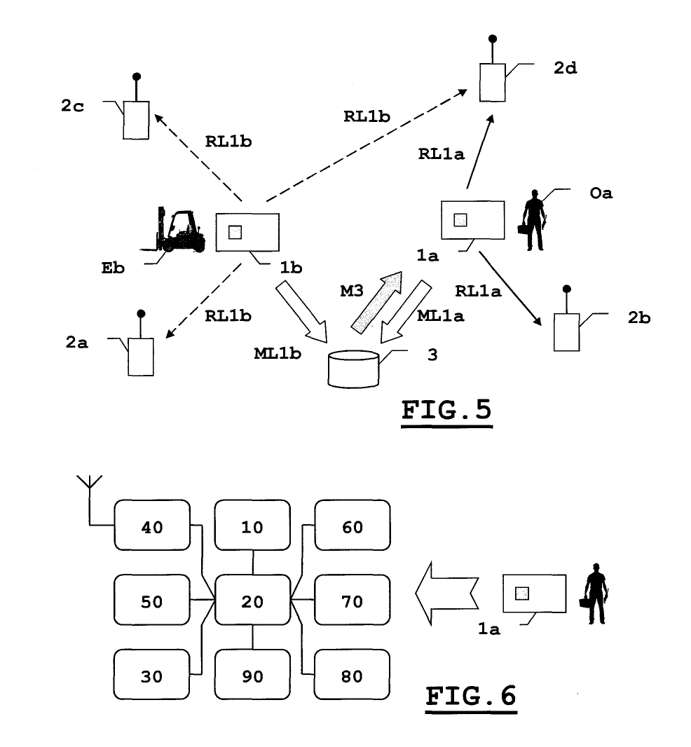

FIG. 5 shows a location system on an industrial site;

FIG. 6 illustrates a structure of a location device according to the invention.

An exemplary installation of a location system according to the invention is shown in FIG. 1. In this Figure, six reference transmitters 2a to 2f are installed in a building 5 having three floors L1, L2 and L3. Pairs of reference transmitters 2a and 2b, 2c and 2d, 2e and 2f are respectively positioned on the ground floor L1, on the first and second floors L2 and L3. The system includes two location devices 1a and 1b respectively associated with two workers Oa and Ob, which are not shown. In option, the system includes means for processing 3 location messages transmitted by the location device 1a and 1b. As an example, said processing means 3 are composed of a radio network collecting data issued by the location devices 1a and 1b coupled with a computer or a central unit for displaying said data in a form understandable by an operator or a machine for processing purposes. According to the example in FIG. 1, the reference transmitters are positioned in columns on each floor of the building. A location area corresponds to each reference transmitter.

According to a preferred embodiment, the reference transmitters each have a unique identification number within the installation. This identification number can be obtained by a self-determination process carried out during the subscription of reference transmitters to the radio collection network. One possible self-determination process consists in each new reference transmitter randomly drawing a serial number in a final list when it is positioned in the building. The reference transmitter then broadcasts its number by radio for the attention of all the reference transmitters already installed. If said number has already been selected by a reference transmitter, the latter informs the reference transmitter being installed that the number has already been drawn. The reference transmitter being installed then removes the number from the list of possible numbers, carries out a new drawing and again waits for an answer. The process may need several alterations until it gets no answer. The number causing no answer from the already installed reference transmitters will be the self-determination number selected for the reference transmitter being installed. The identification of the reference transmitters can be obtained in different ways. An identifier will be more generally used for referring to information dedicated to a reference transmitter making it possible to identify said reference transmitter without any ambiguity.

FIG. 2 illustrates a location system according to the invention. Said system includes a location device 1a including means for receiving identification messages MI2a, MI2b, MI2c, MI2d respectively transmitted by reference transmitters 2a, 2b, 2c and 2d.

According to one embodiment, this location system further includes means for processing 3 a location message ML1a which can be transmitted by the location device 1a. The system described while referring to FIG. 2 is an abstract representation of the system illustrated in FIG. 1, wherein only the location device 1a is shown and for which only the reference transmitters 2a to 2d are able to transmit messages to said location device. The reference transmitters 2e and 2f are too far away and thus out of the communication range of the location device 1a.

The latter includes means for determining among a plurality of reference transmitters each having simultaneously transmitted an identification message, the reference transmitter that is spatially the closest to the device, in other words the reference transmitter located at the shortest distance. In the example shown while referring to FIGS. 1 and 2, the transmitter 2a is a reference transmitter that is the closest to the location device 1a.

In order to determine the latter, the location device 1a analyses the results of collisions of identification messages MI2a to MI2d caused by simultaneous radio communications from the reference transmitters 2a to 2d within radio communication range.

According to the invention, in order to determine 2a as the reference transmitter that is spatially the closest, a method consists for example, for device 1a, in determining the message MI2a as the preponderant message during a collision of identification messages MI2a to MI2d. A preponderant message is an identification message which can be understood by device 1a. According to FIGS. 1 and 2, the message MI2a is the preponderant message and the messages MI2b to MI2d transmitted by the reference transmitters 2b, 2c and 2d are considered as noise filtered by the means for receiving the identification messages from the location device 1a. The transmitter having transmitted the preponderant message is determined as the reference transmitter that is spatially the closest.

In order to identify a reference transmitter among a plurality thereof, the invention provides that an identification message of a reference transmitter includes an identifier dedicated to said transmitter. Then, the location device 1a is able to read the identifier ID2a of the reference transmitter 2a having transmitted said message within the received identification message MI2a. Such identifier can further be transmitted by the location device 1a to processing means 3 through the transmission of a location message ML1a including said identifier.

According to a preferred embodiment, such location message ML1A further includes an identifier dedicated to the location device 1a, so that said processing means 3 can recognise the location device 1a having transmitted a location message among a plurality of location devices such as 1a, 1b according to FIG. 1.

Using processing means such as those shown in connection with FIGS. 1 and 2 is optional. As a matter of fact, according to an alternative embodiment of the invention, a location device 1a or 1b can memorise its location within a memory of its own. As an alternative, said location device can communicate its location directly to the person transporting it using a screen, a loudspeaker or any type of appropriate man-machine interface without said location being transmitted with a location message ML1a to the processing means such as a central unit 3.

Reference transmitters may include means for triggering the means for transmitting an identification message. Said reference transmitters can thus periodically and independently make simultaneous transmissions or possibly in groups. The synchronous triggering of transmissions can be obtained using internal clocks existing in each reference transmitter. Said clocks can be synchronised using radio frequency transmitted time signals. As an example, DCF77 standards drawn up by “Physikalisch-Technische Bundesanstalt” or the JJY drawn up by the “National Institute of Information and Communications Technology” define such signals in North Europe and Japan respectively.

As an alternative, the triggering of identification messages of a group of reference transmitters can be obtained by operating a time synchronisation service available through a connection to a computer network or through an optical connection.

A mode of simultaneous triggering of identification messages can also be obtained using a radio, optical or electric signal transmitted by the reference transmitters themselves or at their own initiative. Then, the reference transmitters synchronise and simultaneously transmit a plurality of identification messages to the location devices.

According to a preferred embodiment, the invention provides a location device with means for transmitting a request for location to a reference transmitter so that the latter transmits backward an identification message. Symmetrically, the invention provides that the means for triggering the transmission of an identification message by a reference transmitter include means for receiving requests for location transmitted by a thus adapted location device. The transmission of an identification message is thus triggered according to instructions possibly contained within the request for location. Then, the transmission can be directly triggered upon reception of said request or can be delayed, and programmed further to an event.

For this purpose, FIG. 3a illustrates a location system similar to the one described in connection with FIG. 2. A device 1a is capable of transmitting a request for location RL1a to reference transmitters 2a, 2b, 2c and 2d. Said reference transmitters simultaneously transmit backward the identification messages MI2a to MI2d to the device 1a upon reception of said request.

FIG. 3b makes it possible to illustrate an alternative to said location system according to the invention. A reference transmitter 2d is the only one able to receive the request for location RL1a sent by a location device 1a. According to FIG. 3b, the transmitter 2d can send a radio, optical or electric signal S to the transmitters 2a, 2b and 2c so that the transmitters 2a to 2d can synchronise and simultaneously transmit their identification messages to the location device 1a. The synchronisation signal S is transmitted by the transmitter 2d upon reception of the location request RL1a.

According to the two above-mentioned preferred embodiments illustrated by FIGS. 3a and 3b, a collision of simultaneously transmitted identification messages is directly caused by the location device. The identification messages transmitted simultaneously by the reference transmitters cause radio collisions. The latter are analysed by the location device which determines the preponderant identification message during the resulting collisions, thus determining the reference transmitter that is spatially the closest.

FIG. 4 illustrates an alternative embodiment of the invention in which a device 1a can know the reference transmitters 2a, 2b, 2c and 2d able to transmit an identification message. Then, said device can implement a method for finding the reference transmitters prior to the implementation of a location process as illustrated in connection with FIG. 2, 3a or 3b. FIG. 4 is somehow an abstract representation of the possible relationship between a device 1a and reference transmitters 2a to 2f installed in building 5 as described in FIG. 1.

The location device 1a includes means for knowing the transmitters able to transmit an identification message. Said means can be more particularly in the form of a transmitters table 11 stored in the memory 10 of a location device such as 1a.

Such table includes one input or several inputs 11a, 11b, 11c and 11d, each being associated with a reference transmitter liable to transmit an identification message. In order to materialise the association of one input with one transmitter, a solution consists in providing a field 110 intended for memorising an identifier dedicated to said transmitter in one input of the table 11.

Thus, in connection with FIG. 4, the table 11 includes a first input 11a including a field 110 containing the identifier ID2a. The input 11a is thus associated with the transmitter 2a. The table 11 further includes three other inputs 11b, 11c and 11d respectively associated with the transmitters 2b, 2c and 2d and each including a field 110 containing respectively the identifiers ID2b, ID2c, ID2d. It can be seen in FIG. 4 shows a table 11 containing no input associated with the transmitters 2e and 2f. In the building 5 in connection with FIG. 1, said transmitters 2e and 2f are located on the upper floor L2. According to a first exemplary application, we can imagine that the device 1a is associated with a person not having the required authorisations to go to said floor L2. Thus, it is useless to provide for a location close to the transmitters 2e and 2f. Then, the device 1a knows only the transmitters 2a to 2d liable to be determined as being the transmitters spatially the closest to the device 1a as per the motions of the holder of device 1a. The device 1a including the thus initialised table 11 can implement a process of location as previously studied in connection with FIG. 3a or 3b by transmitting a request for location to the reference transmitters, the identifiers of which are memorised in inputs 11a to 11d in table 11.

As an alternative solution, the table 11 could contain an additional input dedicated to the transmitter 2e and an input dedicated to the transmitter 2f. However, this embodiment would cause useless requests for location sent to the transmitters 2e and 2f whereas the latter will probably be out of communication range. The invention however does not exclude this utilisation of table 11.

The latter can be pre-established and written in the memory of the location device before the latter implements a location process according to the invention.

The invention further provides that the table 11 can be dynamically composed by a location device.

Then, in order to know the list of the reference transmitters liable to transmit an identification message, the invention provides that a device 1a includes means for transmitting a request for display to a reference transmitter. FIG. 4 shows such a device able to transmit a request RP1a to the transmitters 2a to 2f. The latter are adapted to further include means for receiving such a request for display and to be able to transmit backward a display message including a dedicated identifier. The transmitters 2a to 2b respectively transmit the display messages MP2a to MP2d respectively containing the identifiers ID2A to ID2d. As the transmitters 2e and 2f are spatially very far, they cannot receive the request for display RP1a. They do not answer with a message of display intended for the location device 1a. According to this alternative solution, the invention further provides that the means for knowing the reference transmitters able to transmit an identification message create an input in the transmitters table 11 upon reception of a display message. Then, the thus adapted device 1a can receive a display message MP2a transmitted by the transmitter 2a. As such message MP2a includes the identifier ID2a, the location device 1A can read this identifier and create an input 11a including a field 110 containing said identifier ID2a in table 11. The location device repeats the display process and thus creates the inputs 11b, 11c and 11d.

In order to reduce more particularly the power consumption required for this process of finding the reference transmitters, the invention provides for the possibility for the location device to firstly transmit a request for display using a low transmission power. If no reference transmitter answers, a new request for display is transmitted by the device using a higher transmission power. This process is repeated as long as no reference transmitter answers. If the request has been transmitted using the maximum transmission power and if no transmitter answers, then the location device considers that it cannot implement a location process. A location message mentioning an unknown location can then be transmitted by the location device to the processing means. As an alternative, said message can be given to the holder of said device using an adapted man-machine interface coupled with the location device.

The invention also provides for the possibility that the location device knowing only one reference transmitter determines the latter as being the reference transmitter that is spatially the closest.

In order to optimise the number of requests for location transmitted by a location device, the latter can implement the updating of the transmitters table 11 prior to triggering the location process according to the invention. Such an updating of the transmitters table 11 can also be implemented according to other criteria and at other times.

The invention further provides for the possibility for a location device to repeat the location process.

Then, for improving the reliability of the determination of the reference transmitter that is spatially the closest, a location device can trigger a series of requests for location to the reference transmitters. In order to somehow count the score of the transmitters determined as being the closest, upon each iteration, the transmitters table 11 may include in each input of said table a field 111 for storing a counter. The table 11 counters are written with a common initial value at the beginning of the iteration process. The counter of an input C2i of an input 11i is incremented each time the transmitter 2i is determined by the location device as being the transmitter that is spatially the closest. Then, in connection with FIGS. 1 and 4, the invention provides that upon the first iteration of the location process, the reference transmitter 2a can be considered as being the closest transmitter. The value of the counter C2a of the input 11a which is associated thereto is thus incremented. A second iteration can be commanded by the device 1a in order to confirm or cancel this determination. During a second transmission of requests for location, the value of a counter is in turn incremented. The number of iterations can be set. According to a particular embodiment, the alterations stop as soon as a counter has a value at least equal to twice the value of each other counter.

The invention further provides to modify some settings upon the iteration of the location process. Then, a request for location may include a setting which can be interpreted by a reference transmitter, so that the collisions resulting from the simultaneous transmission of identification messages are organised with varying radio transmission characteristics. For example, when setting a request for location, a location device may request reference transmitters to transmit with a common power, different upon each iteration or even a different common transmission frequency. This method makes it possible to attenuate the effect of some interferences or obstacles which can affect the communication between the reference transmitters and the device.

Upon completion of several iterations, the location device determines the reference transmitter for which the value of the counter is the highest. The latter is determined as being the transmitter that is the closest to the device.

Any other alternative solution for managing the value of the counter of one input in the transmitters table could be implemented. As an example, a location device according to the invention could decrement the value of a counter which would mean that the reference transmitter has been determined as being spatially the closest upon the iteration of a location process. According to this alternative, upon completion of several iterations, the location device would determine the reference transmitter for which the value of the counter is the smallest. The latter would be mentioned as being the reference transmitter that is spatially the closest to the device.

The invention further provides for the possibility for requests for locations to be transmitted to a set of reference transmitters, not entirely but in groups.

The definition of groups can be pre-established and memorised in the table 12 of groups stored in a memory of the device. According to FIG. 4, the groups table is stored in the memory 10 which contains the transmitters table 11. A separate memory for storing the groups table 12 can also be considered.

As an alternative, a location device can also initiate the composition of the group of transmitters and itself establish the table 12 such as described while referring to FIG. 4. According to this embodiment, upon completion of the process of finding transmitters and drawing a transmitters table 11, the means for knowing the transmitters define, for example, groups of two transmitters or duets. Each duet has an input in the groups table 12. Four reference transmitters 2a to 2b being known to the device 1a, the latter defines 6 duets, respectively 2a and 2b, 2a and 2c, 2a and 2d, 2b and 2c, 2b and 2d, and eventually 2c and 2d. Each duet is materialised by an input in the table 12. Each input thus includes two fields 121 and 122 containing the identifiers dedicated to the transmitters. As an example, an input 12a includes the two identifiers ID2a and ID2b. This input thus defines a duet of transmitters 2a and 2b as an alternative, the invention provides that the number of fields of an input in a group table 12 can be three, four or more. Then, according to the invention, not only duets but triplets or quadruplets could be defined.

The means for transmitting requests for location of a location device triggers the transmission of requests to the groups, successively one by one. Then, the location device organises a succession of duels between two reference transmitters. The resulting succession of collisions of identification messages enables the location device to determine in duets the preponderant transmitter 2i and thus to increment the counter C2i in the transmitters table 11 associated with said preponderant transmitter. Upon completion of the successive duels, the device determines the transmitter that is spatially the closest by selecting the input in the transmitters table 11 which contains the counter C2i, the value of which is the highest. The transmitter identifier ID2i contained in said input makes it possible to determine the “winning” transmitter, i.e. the reference transmitter that is spatially the closest.

The invention further provides for the possibility for messages exchanged between reference transmitters and location devices to be enciphered. The invention also proposes to use a private key or public key algorithm.

This enciphering is more particularly useful within the scope of applications where knowing a request for location transmitted by a location device can be operated by a malevolent or non authorised entity. As a matter of fact, the radio transmission of messages can be listened to discretely. For example, the radio communications of a guard during patrols in a classified facility could be listened to. The analysis of communications could supply sensitive information on the operation of the system. The malevolent entity could trigger a request for location and thus induce a reaction of the location system which could be taken advantage of.

In order to reinforce the confidentiality of the messages exchanged between a location device and a reference transmitter or a central unit according to the invention, it may be provided that the location device transmits a public key dedicated thereto within the scope of a request for location or a request for display. The reference transmitters answer by transmitting an identification or display message by enciphering their messages and the identifiers thereof using this key. If need be, a variant can be used within the scope of the enciphering and this variant is transmitted together with the enciphered identifier. The identification or display messages are deciphered by the location device using its private key.

Similarly, a location message transmitted by a location device to the processing means of a location system according to the invention can also be totally or partially enciphered using a private key or public key algorithm. Then, for example, the value of a secret key shared by all the reference transmitters of a location system can be stored in the memory of a location device. The latter can encipher the requests transmitted to the transmitters using the secret key.

In turn, the transmitters can decipher said requests using said secret key. In the case where a public key algorithm is used for enciphering the requests transmitted by a location device, the value of the public key associated with a reference transmitter can be stored in an input of the transmitters table, with said value of the key being transmitted by a display message.

When this alternative embodiment is used, intercepting and/or integrating fraudulent messages becomes extremely difficult for a malevolent person.

A location system according to the invention can indifferently apply to objects, persons and also vegetables.

FIG. 5 shows an exemplary application of the location system relating to workers and the equipment they share. Within an industrial site, several workers among whom Oa use a mobile equipment Eb for carrying out a specific task. This equipment Eb is associated with a location device 1b. The latter implements a location process according to the invention at regular intervals. It thus transmits requests for location RL1b to the reference transmitters 2a, 2c and 2d of a location system. The reference transmitters within the radio range transmit backward identification messages which are not shown in FIG. 5. The location device 1b periodically determines the reference transmitter that is spatially the closest and transmits this information through a location message ML1b to a central unit 3 through a radio collection network.

FIG. 5 further shows a worker Oa which has skills for using equipment Eb. The worker Oa is equipped with a location device 1a according to the invention. In order to find rapidly the equipment Eb within the industrial site, the worker Oa transmits his or her location to the central unit 3 using his or her location device 1a. Therefore, upon the worker's request, the requests RL1a are transmitted by the location device to the transmitters 2b and 2d within communication range. The transmitter that is spatially the closest to the location device 1a is determined by the latter, which transmits the location thereof to the central unit 3 through a radio collection network using a location message ML1a.

The central unit 3 knows the respective positions of the worker Oa and the equipment Eb. The central unit then writes a message M3 which is transmitted to the worker's OA location device 1a to give him or her the position of the equipment Eb. A message M3 can simply be the location message ML1b rerouted by the central 3 to the location device 1b. As an alternative, the location device 1a is able to directly receive said message issued by the location device 1b. The location of the equipment Eb can be displayed on a screen provided on the location device 1a. The location can also be communicated by any other means to the worker Oa through a phone message, for example issued by the central unit.

The invention further provides to adapt a location device able to transmit a request for location so that it includes means for triggering the means for transmitting such a request, for example in the form of an actuator of an alert key or an environmental sensor.

In the example illustrated in FIG. 5, the location device 1b associated with the equipment Eb can include an actuator indicating that said equipment is available or being used. The means for transmitting the transmission of requests for location of the device 1b are triggered only if said actuator indicates that the equipment is available.

A location device can in addition acquire measurements using one or several sensor(s), of a condition indicator of a device, a mechanism or a distant process. As an example, a temperature sensor can be integrated in a location device associated with perishable goods. Said goods can, for example, be stored in an air-conditioned container placed on a palette making it possible to move it. If the temperature inside the container exceeds a predetermined temperature threshold, means for transmitting requests for location are triggered by the location device. An alert in the form of a location message is transmitted by said device to enable the maintenance staff to act within the shortest time.

Another exemplary application of a location system according to the invention consists in providing with a location device an operator carrying out a delicate mission within one or several confined enclosures which can contain toxic gas. As soon as the operator enters the enclosure liable to contain toxic gas, the processing unit of the location device can collect one or several measurement(s) from a remote sensor. The device can further include alert means for informing the operator that the level of toxic gas reaches a hazardous value. The location device can further periodically trigger a location process in order to regularly communicate the location of the operator or even the toxicity level of the latter's immediate environment.

As an alternative, when getting closer to such hazardous areas, the location device implements a location process and collects data from external conditions sensors and/or indicators associated with this area.

The invention can also additionally be applied within the field of floating devices intended, for example, to explore waste water pipes. Therefore, a location device according to the invention is coupled with a floating device of the buoy type. The location device includes a toxicity sensor and can within the motion of the floating device, trigger the transmission of an alert message to the central unit in order to inform it of the location of a possible pollution as well as the measurements carried out using said sensor. As an alternative, the floating device includes said toxicity sensor and transmits the measurement to the location device using the additional communication means of the location device.

As a matter of fact, the invention provides that the location device can include additional communication means for communicating more particularly by radio, Bluetooth, Zigbee, infrared, ultrasounds, sound. It is then possible to exchange information, a location or an alert with a second location device according to the invention or any other communicating entity. The location device can associate with the information already communicated a location process and transmit the whole thing to a central unit by an enriched location message. As an alternative, it can in turn use additional communication means to exchange with a third entity.

As an example, a first thus adapted location device can detect and identify a second location device using said additional communication means. The first device can then trigger a location process and transmit the location common to both devices. The location of the second device detected remains pertinent more particularly if the range authorised by the additional communication means is somehow limited. Then, it becomes possible to locate the person having a low strength radio badge making it possible to establish connections within a very short range. The location device according to the invention associated with a rescuer can transmit the identification of a detected badge and the location of the latter to a central unit. Then, the rescuer can efficiently and accurately ask for help.

The invention also provides that a location message can be dated, stored in the memory and transmitted after a delay. The invention further provides that a location device can include a location record stored in a memory of said device.

FIG. 6 makes it possible to illustrate the structure of a location device 1a according to the invention. The latter can include a calculator 20 capable of implementing a location or display process. The device 1a can further include a memory 10 for storing a transmitters table, a groups table or even a location record according to the alternative embodiments. The device may further include means 30 for providing its power supply. It further includes means 40 for receiving and/or transmitting messages to or from reference transmitters or even location messages processing means of a system. As an alternative, the means 40 may include additional short range communication means for communicating with other location devices or any other third entity.

The device 1a may further include a man-machine interface 50 for communicating with the entity which the device is associated with, alert and/or location information. The computer 20 can trigger a location process as a function of measures issued by one or several environmental detector(s) 60. In addition, said computer 20 can take into account the information issued by actuators 70 for example of the key type to trigger an alert and/or location process.

According to a preferred embodiment, the location device may include means 80 such as an accelerometer to enable the computer 20 to determine a fall or motion situation and thus to trigger an alert and/or location process.

To implement a process, the computer of a location device 1a may include one or several programme(s) stored in a programme memory 90. Said programmes can be written or modified by an external setting device the updating instructions of which are received by the means 40.

The invention additionally provides that a reference transmitter is not fixed. The location system according to the invention makes it possible to obtain a relative position of a device so long as the relative positions between the various reference transmitters of the system are known. Such a system can be installed aboard a ship, a train or any other transportation means. Finally, the position of the reference transmitters installed on a ground can also be varied and be determined by any other means such as GPS for example.

1. A location device including means for receiving an identification message transmitted by a reference transmitter, said identification message including an identifier dedicated to said reference transmitter, wherein the location device includes means for analysing a collision of identification messages and determining a preponderant identification message among the identification messages in order to identify the reference transmitter that is spatially the closest to the device, among the plurality of reference transmitters having each simultaneously transmitted an identification message.

2. A device according to claim 1, further including means for transmitting a request for location to a plurality of reference transmitters so that the reference transmitters simultaneously transmit a return identification message.

3. A device according to claim 2, further including means for triggering the means for transmitting a request for location.

4. A device according to claim 1, further including means for knowing the reference transmitters configured to transmit an identification message thereto.

5. A device according to claim 4, wherein the means for knowing the transmitters configured to transmit an identification message include a transmitters table stored in a memory of said device, with said table including one input for each reference transmitter configured to transmit an identification message, said input including an identifier dedicated to the reference transmitter.

6. A device according to claim 5, wherein the means for knowing the reference transmitters configured to transmit an identification message:
transmit a request for display to any reference transmitter;
receive a return display message transmitted by any reference transmitter configured to answer said request for display;
read an identifier dedicated to said transmitter in said display message;
create one input in the transmitters table for each reference transmitter having transmitted a display message.

7. A device according to claim 17, wherein:
each input of the transmitters table includes a counter;
the means for triggering a request for location trigger a plurality of transmissions of requests to known transmitters;
the means for determining the reference transmitter that is spatially the closest to said device:
determine, for each request for location, the transmitter
the identifier of which is read in the identification message received among the plurality of identification messages which are simultaneously transmitted;
increment the value of the counter in the input of the transmitters table associated with said read identifier;
determine the reference transmitter, the value of the associated counter of which is the highest as the reference transmitter that is spatially the closest to the device, upon completion of all the requests for location.

8. A device according to claim 1, further including means for transmitting a location message including the identifier of the reference transmitter that is spatially the closest.

9. A device according to claim 1, further including means for transmitting an alert message of the radio, sound, vibration and/or light types.

10. A device according to claim 3, wherein the triggering means include a processing unit for analysing a measurement issued by a sensor.

11. A device according to claim 18, further including means for receiving the alert message, and wherein the means for triggering the means for transmitting a request for location trigger said transmitting means upon reception of said alert message.

12. A reference transmitter including means for transmitting an identification message including an identifier dedicated to said reference transmitter, to a location device according to claim 1, and further including means for triggering the means for simultaneously transmitting an identification message with one or several other reference transmitter(s).

13. A reference transmitter according to claim 19, further including means for receiving a request for location transmitted by the location device, and wherein the means for triggering the means for transmitting an identification message trigger said transmitting means if such a request for location has been received by the transmitter.

14. A reference transmitter according to claim 20, further including means for transmitting a display message including an identifier dedicated to said transmitter, as an answer to the reception of a request for display transmitted by the location device.

15. A system characterised in that it includes at least one location device comprising means for receiving an identification message transmitted by a reference transmitter, said identification message including an identifier dedicated to said reference transmitter, and means for analysing a collision of identification messages and determining a preponderant identification message among the identification messages in order to identify the reference transmitter that is spatially the closest to the device, among the plurality of reference transmitters having each simultaneously transmitted an identification message, and at least two reference transmitters according to claim 12.

16. A system comprising a location device having means for receiving an identification message transmitted by a reference transmitter, said identification message including an identifier dedicated to said reference transmitter, means for analysing a collision of identification messages and determining a preponderant identification message among the identification messages in order to identify the reference transmitter that is spatially the closest to the device, among the plurality of reference transmitters having each simultaneously transmitted an identification message, and means for transmitting a location message including the identifier of the reference transmitter that is spatially the closest, at least two reference transmitters according to claim 12 and processing means for a location message transmitted by said location device.

17. A device according to claim 3, wherein the means for knowing the transmitters configured to transmit an identification message include a transmitters table stored in a memory of said device, with said table including one input for each reference transmitter configured to transmit an identification message, said input including an identifier dedicated to the reference transmitter.

18. A device according to claim 3, further including means for transmitting an alert message of the radio, sound, vibration and/or light types.

19. A reference transmitter including means for transmitting an identification message including an identifier dedicated to said reference transmitter, to a location device according to claim 2, and further including means for triggering the means for simultaneously transmitting an identification message with one or several other reference transmitter(s).

20. A reference transmitter including means for transmitting an identification message including an identifier dedicated to said reference transmitter, to a location device according to claim 6, and further including means for triggering the means for simultaneously transmitting an identification message with one or several other reference transmitter(s).
